(19) United States
(12) Patent Application Publication
(10) Pub. No.: US 2024/0009742 A1
(43) Pub. Date: Jan. 11, 2024

(54) A DRILLING GUIDE WITH EASILY CONFIGURED MOUNTING HOLES FOR HANDLES AND THE INSERTION RODS THEREOF

(71) Applicant: SUPER POWER TOOLS CO., LTD., Taichung City (TW)

(72) Inventor: Yu-Chun LIU, Taichung City (TW)

(21) Appl. No.: 17/811,674

(22) Filed: Jul. 11, 2022

(51) Int. Cl. B23B 47/28

(52) U.S. Cl. CPC B23B 47/287

(57) ABSTRACT

A drilling guide with easily configured mounting holes for handles and insertion rods thereof includes a base, an abutting bar, two hole site structures and two insertion rods. The abutting bar slides back and forth in the second direction on the back side of the base. The hole site structures can oppositely slide in the first direction on the base, and penetrate a channel respectively, so that the drilling tool is aligned with an object on the back side of the base through the channels to process two mounting holes. The insertion rods are removably disposed in the channels. The diameter of the insertion rod changes in axial direction. The insertion rod is axially located in the channel, and the insertion rod protrudes from the bolt, and axially enters the nail hole of the handle, so as to set the distance of the mounting holes to fit the handle.

### CROSS-REFERENCE TO RELATED U.S. APPLICATIONS

Not applicable.

### BACKGROUND OF THE INVENTION

### 1. Field of the Invention

The present invention relates generally to a fixture for drilling, and more particularly to a drilling guide with easily configured mounting holes for handles and the insertion rods thereof. The drilling guide is a fixture used for drilling mounting holes matching the handle in the objects to be installed with a handle, such as cabinets, drawers or door leaves, so that the distance between the mounting holes can match the configuration requirement of the handle.

### 2. Description of Related Art Including Information Disclosed Under 37 CFR 1.97 and 37 CFR 1.98

A handle which can be installed on such objects as cabinets, drawers or door leaves, includes a gripping part for gripping formed on the front side, and two nail holes for screws to lock in are formed on the back side. When the handle is configured on the object, two mounting holes shall be drilled beforehand in the location of the handle on the object, and the distance between the mounting holes is matched with the distance between the nail holes. Then, the back side of the handle is leaned on the front side of the object, and the two screws pass through the mounting holes from the back to the front to lock in the nail holes, such that the installation of the handle is completed.

The handles of the same specification are usually installed in the same positions on multiple objects, such as cabinets, drawers or door leaves. The handles are configured on multiple objects one by one, and each handle is located in the same position of each object. A lot of time will be spent on measuring and drawing the centers of the mounting holes for each object, so the sites of the mounting holes in each object can be determined rapidly by using a drilling fixture.

The drilling fixture includes a master disc, an abutting bar and two hole site pieces. The abutting bar is disposed on the back side of the master disc. The abutting bar can slide close to or far from two opposite sides of the master disc. The abutting bar forms an abutting surface. The abutting surface is orthogonal to the sliding direction of the abutting bar. The master disc penetrates two elongated embedding grooves. The elongated extension direction ofthe embedding grooves is parallel to the abutting surface. Several graduations are formed on the front side of the master disc. The graduations are configured at intervals in the elongated direction of the embedding grooves. The hole site pieces are disposed in the embedding grooves respectively. The hole site pieces can slide back and forth in the elongated direction of the embedding grooves respectively. The graduations indicate the spacing of the hole site pieces. The hole site piece axially penetrates a tooling hole. The tooling hole is axially penetrated by a drilling tool. The drilling tool is used for processing the object to form the mounting hole. The hole site pieces are screwed with a dead ring axially through the embedding groove respectively. The dead ring abuts on the back side of the master disc. Several strip ridges are configured on the radial circumference of the dead ring. The ridges are convenient for clamping the fastener and rotating the dead ring with fingers.

When the said drilling fixture is used for processing the mounting hole, the distance of the nail holes of the handle is measured at first, the hole site pieces are slid along the embedding grooves on the front side of the master disc based on the measurement result, so that the hole site pieces are opposite to the corresponding graduations respectively, and then the dead ring is rotated from the back side of the master disc to abut on the back side of the master disc tightly. The hole site pieces are located, and the dead ring is rotated by the fingers on the back side of the master disc, so as to avoid shielding the sight on checking whether the hole site piece is aligned with the corresponding graduation. The abutting bar is slid and the locating piece is operated to locate the abutting bar, and then the master disc is leaned on the front side of the object, and the abutting surface abuts on one side of the object. The drilling tool is operated to process the object through the hole site pieces to form the mounting hole. The distance of the mounting holes is matched with the nail holes of the handle. To process the mounting hole for another object, it is unnecessary to readjust the hole site piece and the abutting bar. The mounting hole can be processed for the handles of the same specification matched with multiple objects rapidly and in large quantities.

The distance of the nail holes is measured by using a measuring tool, and the hole site pieces are moved according to the measurement result. The setting process of the distance between the hole site pieces is complicated.

The operation of the measuring tool and visual interpretation of the measuring tool are likely to cause errors in judging the distance of the nail holes, and the hole site pieces are slid respectively and located respectively. The positioning operation of each hole site piece may have errors. The accumulation of multiple errors is likely to make the distance of the processed mounting holes hard to match the distance of the nail holes, so that in the installation of the handle on the object, the mounting hole and the nail hole deviate from each other, the quality of installation is influenced.

### BRIEF SUMMARY OF THE INVENTION

The fundamental purpose of the present invention is to provide a drilling guide with easily configured mounting holes for handles and the insertion rods thereof.

Based on the said purpose, the technical characteristic of problem solving of the present invention is that the drilling guide with easily configured mounting holes for handles includes a base which is a plate-like structure. The base penetrates two elongated guide channels. The guide channels are configured at intervals in the first direction. The guide channels extend in the first direction respectively. Two limit surfaces are formed in the first direction on the back side of the base. The limit surfaces are opposite to each other in the second direction. The first direction is orthogonal to the second direction. The first direction and the second direction are orthogonal to the thickness direction of the base respectively. The guide channels are located between the limit surfaces respectively.

An abutting bar is provided, which can slide back and forth in the second direction. On the back side of the base, two positioning elements pivotally penetrate the base to locate the abutting bar. The abutting bar forms an abutting surface orthogonal to the second direction.

Two hole site structures are disposed in the guide channels respectively. The guide channels guide the hole site structures to move back and forth in the first direction respectively. The hole site structure includes a slider, a screwing piece and a bolt. The slider is disposed on the front side of the base. The screwing piece is disposed on the back side of the base. The bolt is screwed in the screwing piece through the slider. The bolt and the screwing piece oppositely clamp the slider and the base, so as to locate the hole site structure. Two planes are formed in axial direction outside the radial direction the screwing piece. The planes are close to the limit surfaces respectively. The limit surfaces limit the rotation of the screwing piece. The bolt axially penetrates a channel. The channel allows a drilling tool to penetrate in axial direction, so that the drilling tool is aligned with an object on the back side of the base through the channel of the hole site structures to process two mounting holes for installing a handle.

Two insertion rods are elongated bodies, which are removably disposed in the channels. The diameter of the insertion rod changes in axial direction. The insertion rod is axially located in the channel, and the insertion rod protrudes from the bolt, and axially enters the nail hole of the handle, so as to set the distance of the mounting holes to fit the handle.

The main effect and advantage of the present invention are that the hole site structures can be moved intuitively after the insertion rods are disposed in the channel, the insertion rods enter the nail holes respectively, so that distance of the channels is matched with the distance of the nail holes, the distance of the mounting holes is set easily and rapidly.

### BRIEF DESCRIPTION OF THE SEVERAL VIEWS OF THE DRAWINGS

FIG. 1 is the stereogram of the Embodiment 1 of the present invention.

FIG. 2 is the three-dimensional exploded diagram of the Embodiment 1 of the present invention.

FIG. 3 is the front view of insertion rods in the Embodiment 1 of the present invention.

FIG. 4 is the operating state diagram of two-channel distance setting in the Embodiment 1 of the present invention.

FIG. 5 is the 5-5 sectional view of FIG. 4.

FIG. 6 is the drawing of partial enlargement of FIG. 5.

FIG. 7 is the 7-7 sectional view of FIG. 5.

FIG. 8 is the front view of operating state in the Embodiment 1 of the present invention.

FIG. 9 is the front view of another operating state in the Embodiment 1 of the present invention.

FIG. 10 is the front view of insertion rods in the Embodiment 1 of the present invention.

FIG. 11 is the front view of insertion rods in the Embodiment 3 of the present invention.

### DETAILED DESCRIPTION OF THE INVENTION

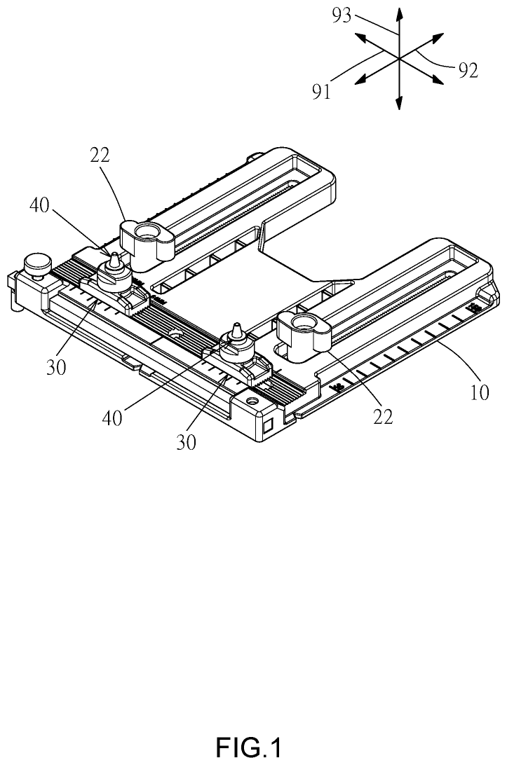

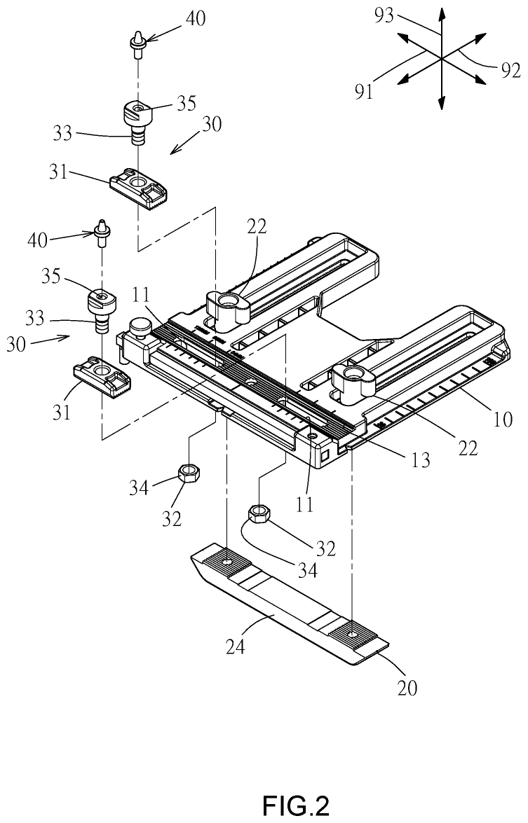

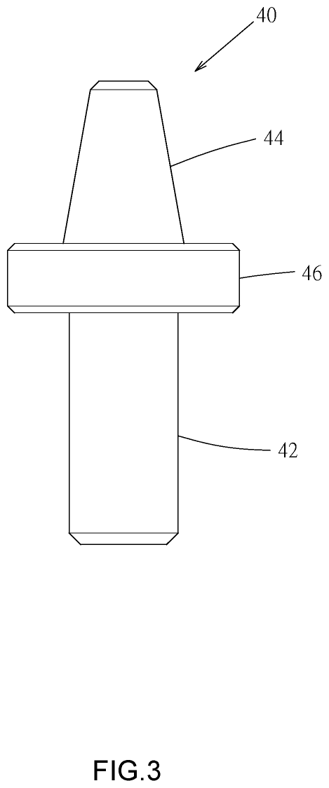

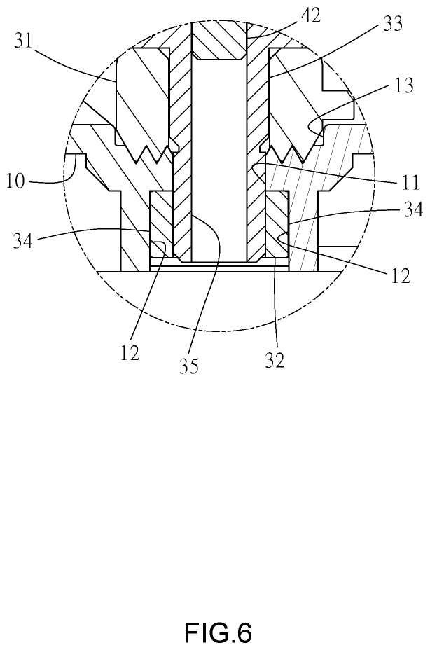

As shown in FIG. 1 to FIG. 9, the Embodiment 1 of the present invention includes a base 10, an abutting bar 20, two hole site structures 30 and two insertion rods 40. The base 10 is a plate-like structure. The base 10 penetrates two elongated guide channels 11. The guide channels 11 extend in the first direction 91, and the guide channels 11 are configured at intervals in the first direction 91. Two limit surfaces 12 are formed in the first direction 91 on the back side of the base 10. The limit surfaces 12 are opposite to each other in the second direction 92. The first direction 91 is orthogonal to the second direction 92. The first direction 91 and the second direction 92 are orthogonal to the thickness direction 93 of the base 10 respectively. The guide channels 11 are located between the limit surfaces 12 respectively.

The abutting bar 20 can slide back and forth in the second direction 92 on the back side of the base 10. Two positioning elements 22 penetrate through the base 10 to fix the abutting bar 20. An abutting surface 24 is formed on the side of the abutting bar 20 in proximity to the guide channel 11. The abutting surface 24 is orthogonal to the second direction 92.

The hole site structures 30 are disposed in the guide channels 11 respectively. The guide channels 11 guide the hole site structures 30 to move back and forth in the first direction 91 respectively. The hole site structure 30 includes a slider 31, a screwing piece 32 and a bolt 33. The slider 31 is disposed on the front side of the base 10. The screwing piece 32 is disposed on the back side of the base 10. The bolt 33 is screwed in the screwing piece 32 through the slider 31. The bolt 33 and the screwing piece 32 oppositely clamp the slider 31 and the base 10, so as to locate the hole site structure 30. Two planes 34 are formed in axial direction outside the radial direction of the screwing piece 32. The planes 34 are close to the limit surfaces 12 respectively. The limit surfaces 12 limit the rotation of the screwing piece 32. The bolt 33 axially penetrates a channel 35. The channel 35 allows a drilling tool (not shown in the figure) to penetrate in axial direction, so that the drilling tool is aligned with an object 94 on the back side of the base 10 through the channel 35 of the hole site structures 30 to process two mounting holes for installing a handle 95 (not shown in the figure).

The insertion rods 40 are elongated bodies, the insertion rods 40 are removably disposed in the channels 35. The diameter of the insertion rod 40 changes in axial direction. The insertion rod 40 is axially located in the channel 35, and the insertion rod 40 protrudes from the bolt 33, and axially penetrates the nail hole 96 of the handle 95, so as to set the distance of the mounting holes to fit the handle 95.

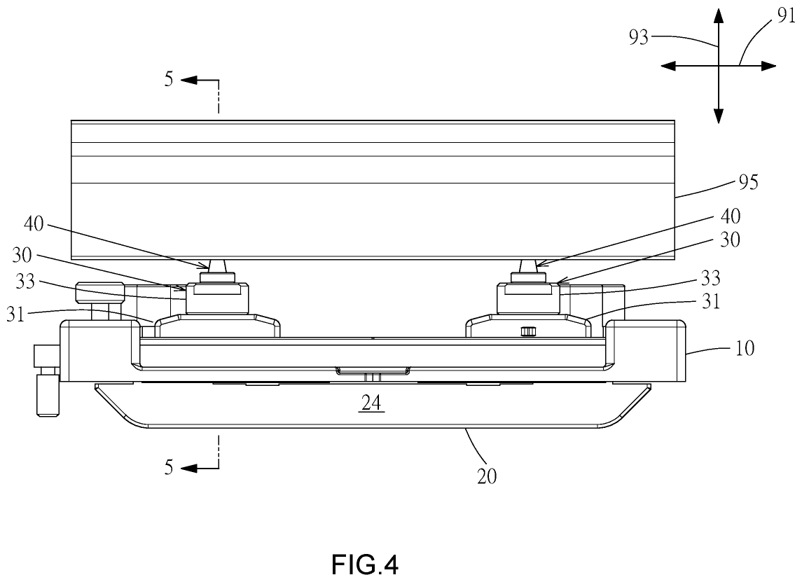

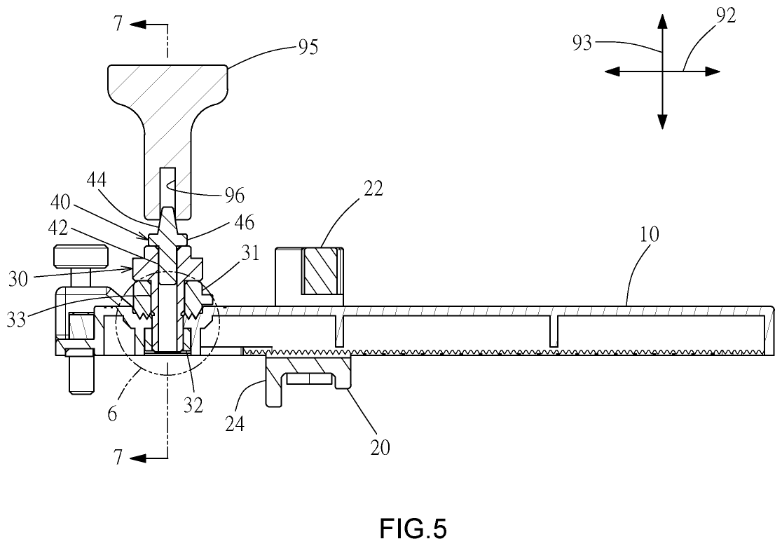

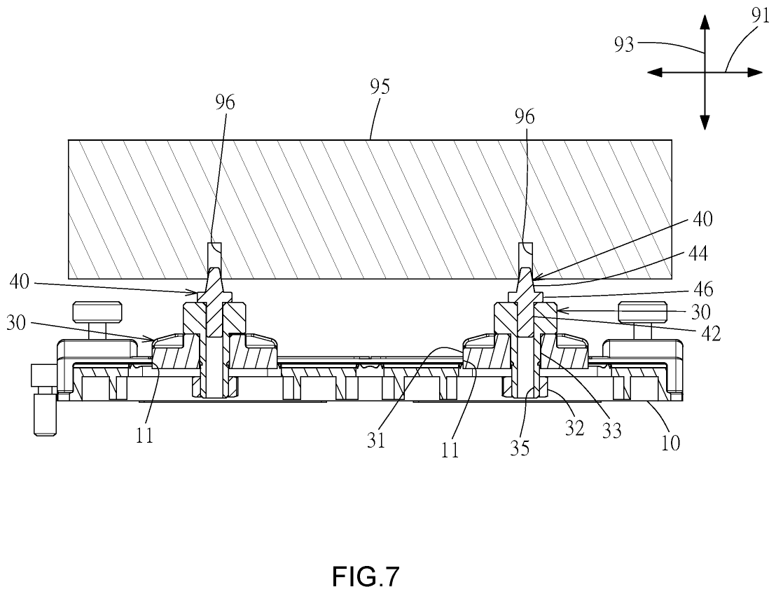

Before the mounting hole for installing the handle 95 is drilled in the object 94, as shown in FIG. 4, FIG. 5 and FIG. 7, the insertion rods 40 are disposed in the channels 35 respectively, the handle 95 is disposed above the insertion rods 40, the hole site structures 30 are move respectively along the guide channels 11, so that the insertion rods 40 are inserted in the nail holes 96 respectively, and then the bolt 33 is rotated. The bolt 33 and the corresponding the screwing piece 32 oppositely tighten the slider 31 and the base 10, the hole site structures 30 are located, and the distance of the channels 35 is equal to the distance of the nail holes 96.

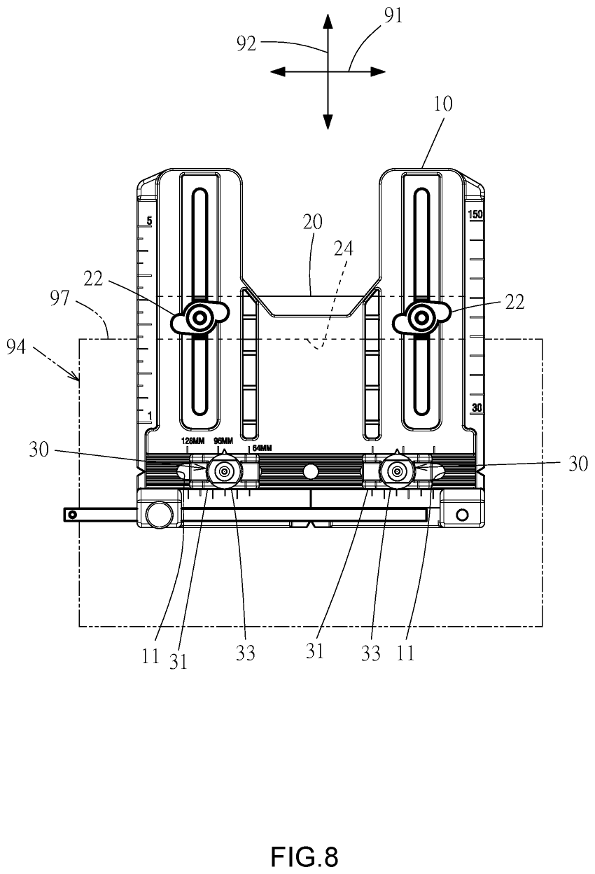

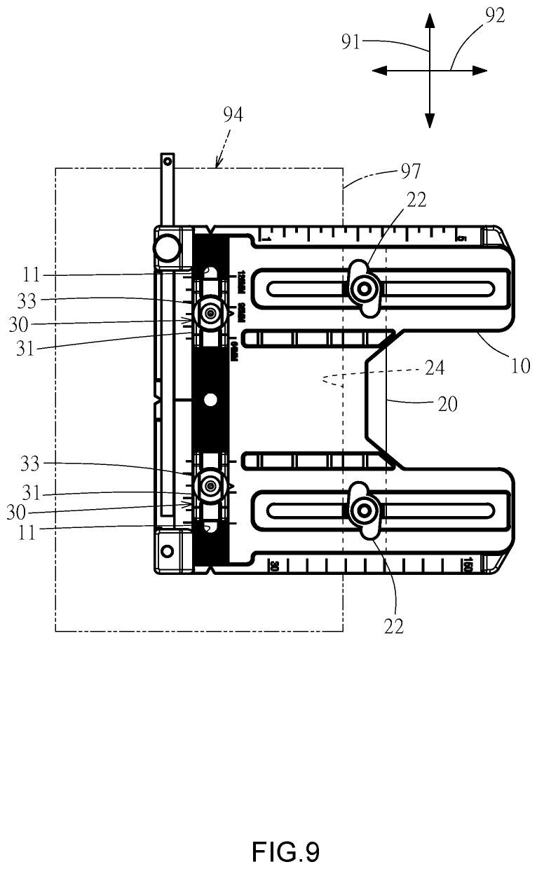

The handle 95 is removed and the insertion rod 40 is drawn out of the channel 35. The location of the abutting bar 20 is adjusted according to the preset location of the handle 95 on the object 94, as shown in FIG. 8 and FIG. 9. The base 10 leans on the front side of the object 94, according to the configuration requirement for the handle 95 on the object 94. The abutting bar 20 leans on the corresponding edge 97 of the object 94. The abutting surface 24 abuts on the edge 97 to locate the base 10, so that the mounting holes can be drilled in the object 94 by using the drilling tool (not shown in the figure) through the channels 35, and the distance between the mounting holes is matched with the distance between the nail holes 96. To process the mounting hole for another object 94, it is unnecessary to readjust the hole site structures 30 and the abutting bar 20, and the mounting hole can be processed in multiple objects 94 for the handle 95 rapidly and in large quantities.

The hole site structure 30 is matched with the insertion rod 40 in the Embodiment 1. It is unnecessary to measure the distance between the nail holes 96 of the handle 95 beforehand. After the insertion rod 40 is disposed in the channel 35, the hole site structures 30 are moved intuitively. The insertion rods 40 enter the nail holes 96 respectively. The distance of the channels 35 can be matched with the distance of the nail holes 96, the distance of the mounting holes is set easily and rapidly. On the other hand, the bolt 33 is rotated on the front side of the base 10, so as to locate or dislocate the hole site structure 30 in the base 10.

The insertion rod 40 has a first rod section 42 and a second rod section 44. The first rod section 42 forms one end of the insertion rod 40. The second rod section 44 forms the other end of the insertion rod 40. The first rod section 42 is axially inserted in the channel 35. The second rod section 44 is axially inserted in the nail hole 96. The radial circumference of the second rod section 44 is conical, so as to guide the second rod section 44 to enter the nail hole 96, and the second rod section 44 can enter the nail holes 96 in different apertures. Thus, the usability is enhanced.

The insertion rod 40 has a bulge 46. The bulge 46 is located between the first rod section 42 and the second rod section 44. The outside diameter of the bulge 46 is larger than the inside diameter of the channel 35. When the first rod section 42 is inserted in the channel 35, the bulge 46 leans on the bolt 33, the bolt 33 stops the bulge 46, the insertion rod 40 is located in the channel 35.

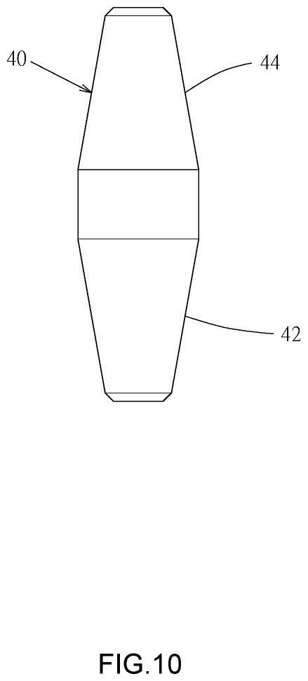

A slot 13 is formed in the thickness direction 93 on the front side of the base 10. The guide channels 11 are formed in the slot 13 respectively. The slider 31 is pivotally embedded in the slot 13. As shown in FIG. 10, the difference from Embodiment 1 is that the insertion rod 40 is free of the bulge 46 of Embodiment 1, and the radial circumference of the first rod section 42 is conical, so as to guide the first rod section 42 to enter the channel 35. The inside diameter of the channel 35 is between the minimum outside diameter and maximum outside diameter of the first rod section 42. When the first rod section 42 enters the channel 35, the radial circumference of the first rod section 42 props one end of the channel 35, one end of the channel 35 stops the first rod section 42, so that the insertion rod 40 is located in the channel 35.

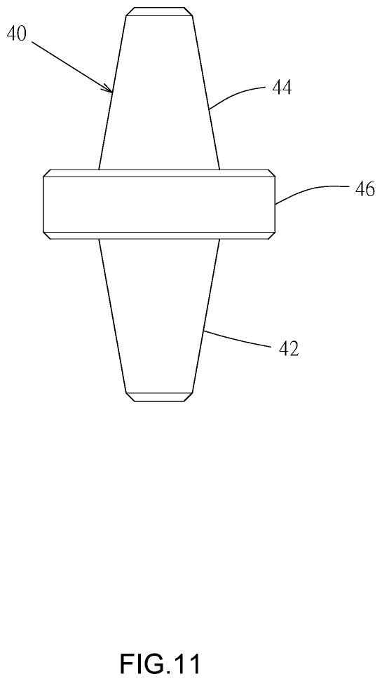

As shown in FIG. 11, the main difference of Embodiment 3 from Embodiment 1 is that the radial circumference of the first rod section 42 is conical, so as to guide the first rod section 42 to enter the channel 35.

I claim:

1. A drilling guide with easily configured mounting holes for handles, including:
a base which is a plate-like structure, the base penetrates two elongated guide channels, the guide channels are configured at intervals in the first direction, the guide channels extend in the first direction respectively, two limit surfaces are formed in the first direction on the back side of the base, the limit surfaces are opposite to each other in the second direction, the first direction is orthogonal to the second direction, the first direction and the second direction are orthogonal to the thickness direction of the base respectively, the guide channels are located between the limit surfaces respectively;
an abutting bar which can slide back and forth in the second direction is disposed on the back side of the base, two positioning elements pivotally penetrate the base to locate the abutting bar, the abutting bar forms an abutting surface, the abutting surface is orthogonal to the second direction;
two hole site structures are disposed in the guide channels respectively, the guide channels guide the hole site structures to move back and forth in the first direction respectively, the hole site structure includes a slider, a screwing piece and a bolt, the slider is disposed on the front side of the base, the screwing piece is disposed on the back side of the base, the bolt is screwed in the screwing piece through the slider, the bolt and the screwing piece oppositely clamp the slider and the base, so as to locate the hole site structure, two planes are formed in axial direction outside the radial direction the screwing piece, the planes are close to the limit surfaces respectively, the limit surfaces limit the rotation of the screwing piece, the bolt axially penetrates a channel, the channel allows a drilling tool to penetrate in axial direction, so that the drilling tool is aligned with an object on the back side of the base through the channel of the hole site structures to process two mounting holes for installing a handle; and
two insertion rods are elongated bodies, the insertion rods are removably disposed in the channels, the diameter of the insertion rod changes in axial direction, the insertion rod is axially located in the channel, and the insertion rod protrudes from the bolt, and axially enters the nail hole of the handle, so as to set the distance of the mounting holes to fit the handle.

2. The drilling guide with easily configured mounting holes for handles defined in claim 1, wherein the insertion rod has a first rod section and a second rod section, the first rod section forms one end of the insertion rod, the second rod section forms the other end of the insertion rod, the first rod section is axially inserted in the channel, the second rod section is axially inserted in the nail hole of the handle.

3. The drilling guide with easily configured mounting holes for handles defined in claim 2, wherein the radial circumference of the second rod section is conical, so as to guide the second rod section to enter the nail hole.

4. The drilling guide with easily configured mounting holes for handles defined in claim 2, wherein the insertion rod has a bulge, the bulge is located between the first rod section and the second rod section, the outside diameter of the bulge is larger than the inside diameter of the channel, so that the bulge leans on the bolt to locate the insertion rod.

5. The drilling guide with easily configured mounting holes for handles defined in claim 2, wherein the radial circumference of the first rod section is conical, the inside diameter of the channel is between the minimum outside diameter and maximum outside diameter of the first rod section.

6. The drilling guide with easily configured mounting holes for handles defined in claim 3, wherein the radial circumference of the first rod section is conical, so as to guide the first rod section to enter the channel.

7. The drilling guide with easily configured mounting holes for handles defined in claim 1, wherein a slot is formed in the thickness direction on the front side of the base, the guide channels are formed in the slot respectively, the slider is pivotally embedded in the slot.

8. An insertion rod for said drilling guide defined in claim 1, the insertion rod makes the drilling guide easy to set the mounting holes to fit a handle, the insertion rod is an elongated body, the diameter of the insertion rod changes in axial direction, so that the insertion rod is axially located in the drilling guide.

9. The insertion rod defined in claim 8, wherein the insertion rod has a first rod section and a second rod section, the first rod section forms one end of the insertion rod, the second rod section forms the other end of the insertion rod, the first rod section is located in the drilling guide, the second rod section is axially inserted in the nail hole of the handle.

10. The insertion rod defined in claim 9, wherein the radial circumference of the second rod section is conical.

11. The insertion rod defined in claim 9, wherein the insertion rod has a bulge, the bulge is located between the first rod section and the second rod section, the outside diameter of the bulge is larger than the outside diameter of the first rod section.

12. The insertion rod defined in claim 9, wherein the radial circumference of the first rod section is conical.

13. The insertion rod defined in claim 10, wherein the radial circumference of the first rod section is conical.
